(19) United States
(12) Patent Application Publication
(10) Pub. No.: US 2014/0155519 A1
(43) Pub. Date: Jun. 5, 2014

(54) TIRE WITH A TREAD COMPRISING AN EMULSION SBR HAVING A HIGH TRANS CONTENT

(71) Applicant: COMPAGNIE GENERALE DES ETABLISSEMENTS MICHELIN, Clermont-Ferrand (FR)

(72) Inventor: Claude Ringot, Clermont-Ferrand (FR)

(21) Appl. No.: 14/116,112

(22) PCT Filed: May 4, 2012
(86) PCT No.: PCT/EP12/58263

§ 371 Date: Feb. 3, 2014

(30) Foreign Application Priority Data
May 6, 2011 (FR) 1153880

(51) Int. Cl. C08L 9/06

(52) U.S. Cl. CPC C08L 9/06
USPC 523/156

(57) ABSTRACT

The present invention relates to a tyre, the tread of which comprises a rubber composition comprising at least:
from 40 to 100 phr of an emulsion styrene/butadiene copolymer (E-SBR), referred to as first diene elastomer, the content of trans-1,4-butadienyl units of which is greater than 50% by weight of the total of the butadienyl units;
optionally, from 0 to 60 phr of another diene elastomer referred to as second diene elastomer;
from 90 to 150 phr of a reinforcing inorganic filler;
a plasticizing system comprising:
   according to a content A of between 10 and 60 phr, a hydrocarbon resin exhibiting a Tg of greater than 20° C.;
   according to a content B of between 10 and 60 phr, a plasticizer which is liquid at 20° C., the Tg of which is less than −20° C.;
   it being understood that A+B is greater than 45 phr.

The use of such an emulsion SBR, in combination with high contents of inorganic filler and of plasticizer, in the tread compositions of the tyre according to the invention makes it possible to obtain a greatly improved wet grip, in comparison with a control composition, without damaging the rolling resistance.

### CROSS-REFERENCE TO PRIOR APPLICATIONS

This application claims the benefit of the filing date of PCT Application No. PCT/EP2012/058263, filed May 4, 2012, which claims the benefit of the filing date of the French Application No. 1153880, filed May 6, 2011, each document being incorporated by reference in its entirety for all purposes.

### BACKGROUND 1. Field

The present invention relates to tire treads and to rubber compositions based on a diene elastomer which can be used for manufacture of such tire treads.

2. Description of Related Art

A tire tread has to meet, in a known way, a large number of often conflicting technical requirements, including a low rolling resistance, a high wear resistance and both a high dry grip and a high wet grip.

This compromise in properties, in particular from the viewpoint of the rolling resistance and the wear resistance, was able to be improved in recent years with regard to energy-saving “Green Tires”, intended in particular for passenger vehicles, by virtue in particular of the use of novel weakly hysteretic rubber compositions having a characteristic of being reinforced predominantly with specific inorganic fillers, described as reinforcing, in particular with highly dispersible silicas (HDSs), capable of rivalling, from the viewpoint of the reinforcing power, conventional tire-grade carbon blacks.

### SUMMARY

The improvement in the grip properties, particularly on wet ground, without significantly damaging the rolling resistance, is today a continual preoccupation of tire designers.

On continuing of their research studies, the Applicant Companies have discovered a specific rubber composition which, used as tire tread, makes it possible to achieve the above objective.

Thus, a first embodiment of the invention is a tire, the tread of which comprises a rubber composition comprising at least:
from 40 to 100 phr of an emulsion styrene/butadiene copolymer “E-SBR”, referred to as first diene elastomer, the content of trans-1,4-butadienyl units of which is greater than 50% by weight of the total of the butadienyl units;
optionally, from 0 to 60 phr of another diene elastomer referred to as second diene elastomer;
from 90 to 150 phr of a reinforcing inorganic filler;
a plasticizing system comprising:
   according to a content A of between 10 and 60 phr, a hydrocarbon resin exhibiting a Tg of greater than 20° C.;
   according to a content B of between 10 and 60 phr, a plasticizer which is liquid at 20° C., the Tg of which is less than −20° C.;
   it being understood that A+B is greater than 45 phr.

The tires described herein are intended in particular to equip motor vehicles of passenger type including 4×4 vehicles (having four wheel drive) and SUV (Sport Utility Vehicles) vehicles, two-wheel vehicles (in particular motorcycles) as well as industrial vehicles chosen in particular from vans and heavy-duty vehicles, such as buses or heavy road transport vehicles, for example lorries.

The invention and its advantages will be easily understood in the light of the description and implementational examples which follow.

### I—DETAILED DESCRIPTON OF THE INVENTION

In the present description, unless expressly indicated otherwise, all the percentages (%) shown are presented by weight.

“Diene” elastomer (or without distinction rubber) is understood to mean an elastomer resulting at least in part (that is to say, a homopolymer, or a copolymer) from diene monomer(s) (i.e., carrying two conjugated or nonconjugated carbon-carbon double bonds). “Isoprene elastomer” is understood to mean an isoprene homopolymer or copolymer, in other words a diene elastomer chosen from the group consisting of natural rubber (NR), synthetic polyisoprenes (IRs), the various copolymers of isoprene and the mixtures of these elastomers.

The abbreviation “phr” means parts by weight per 100 parts of elastomer or rubber (of the total of the elastomers, if several elastomers are present).

Moreover, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

All the glass transition temperature (“Tg”) values are measured in a known way by DSC (Differential Scanning calorimetry), according to Standard ASTM D3418 (1999), on elastomers in the dry and noncrosslinked state. The microstructure of the elastomers is well known to the suppliers of elastomers, determinable in particular by NMR analysis or IR analysis.

The tire of the invention thus has the essential characteristic that its tread comprises a rubber composition comprising at least one specific emulsion styrene/butadiene copolymer, one reinforcing inorganic filler and one specific plasticizing system, which components will be described in detail below.

### I.1—Diene Elastomers

The composition of the tread of the tire according to the invention has the essential characteristic of comprising, as first diene elastomer, from 40 to 100 phr of an emulsion styrene/butadiene copolymer (E-SBR), the content of trans-1,4-butadienyl units of which is greater than 50% by weight of the total of the butadienyl units (as a reminder, 1,2-, cis-1,4- and trans-1,4-units). Preferably, this trans-1,4-content is greater than 60% by weight, more preferably between 60% and 80% by weight, of the total of the butadienyl units.

According to another preferred embodiment of the invention, the above E-SBR exhibits a styrene content of at most 50% (% by weight of the E-SBR), more preferably of between 10% and 50%, more preferably still within a range from 20% to 45%.

Emulsion SBR copolymers, also known as E-SBR copolymers, are copolymers well known to a person skilled in the art of tires and rubber. They are random diene copolymers, in contrast in particular to copolymers of the thermoplastic type comprising styrene blocks and butadiene blocks; they are polymerized as an emulsion in the presence of water and of an emulsifying agent, generally according to a cold process. Mention may in particular be made of those of the 1500 series (not extended with oil) or those of the 1700 series (extended with oil, e.g. SBR 1723, SBR 1732 and SBR 1739). Their Tg is preferably between −65° C. and −25° C.

The person skilled in the art knows how to modify the microstructure of a copolymer based on styrene and butadiene, in particular of an E-SBR, in order to increase and adjust its Tg, in particular by varying the contents of styrene, of 1,2-bonds or also of trans-1,4-bonds of the butadiene part.

Preferably, the content of first diene elastomer, in the rubber composition, is within a range from 45 to 100 phr, more preferably from 50 to 100 phr.

The E-SBR copolymer described above can be combined with at least one optional second diene elastomer, different from the first diene elastomer (that is to say, from an E-SBR copolymer, the content of trans-1,4-butadienyl units of which is greater than 50%), the said second diene elastomer being present at a content by weight which is consequently at most equal to 60 phr, preferably at most equal to 55 phr.

This optional second diene elastomer is preferably selected from the group consisting of natural rubber (NR), synthetic polyisoprenes (IRs), polybutadienes (BR), butadiene copolymers, isoprene copolymers and the mixtures of these elastomers; such copolymers are more preferably selected from the group consisting of styrene/butadiene copolymers (SBRs) (other than the first diene elastomer having a high trans content), isoprene/butadiene copolymers (BIRs) and isoprene/styrene copolymers (SIRs). More preferably still, the second diene elastomer is selected from the group consisting of polybutadienes, natural rubber and their mixtures.

This possible second diene elastomer can have any microstructure, which depends on the polymerization conditions used, in particular on the presence or absence of a modifying and/or randomizing agent and on the amount of modifying and/or randomizing agent employed. The second elastomer can, for example, be a block, random, sequential or microsequential elastomer and be prepared in dispersion or in solution; it can be coupled and/or star-branched or else functionalized with a coupling and/or star-branching or functionalization agent. Suitable in particular among the latter are polybutadiene homopolymers (BR) and in particular those having a content (molar %) of 1,2-units of between 4% and 80% or those having a cis-1,4-content (molar %) of greater than 80%; polyisoprene homopolymers (IR); solution butadiene/styrene copolymers (SBRs) and in particular those having a Tg of between 0° C. and −70° C. and more particularly between −10° C. and −60° C., a styrene content of between 5% and 60% by weight and more particularly between 20% and 50%, a content of 1,2-bonds of the butadiene part of between 4% and 75% and a content of trans-1,4-bonds of between 10% and 80%; butadiene/isoprene copolymers (BIRs) and in particular those having an isoprene content of between 5% and 90% by weight and a Tg from −40° C. to −80° C.; or isoprene/styrene copolymers (SIRs) and in particular those having a styrene content of between 5% and 50% by weight and a Tg of between −50° C. and −5° C.

According to another preferred embodiment, the second diene elastomer is a polybutadiene more preferably having a content (molar %) of cis-1,4-bonds of greater than 90%.

According to another preferred embodiment, the second diene elastomer is an isoprene elastomer, more preferably natural rubber or a synthetic polyisoprene of the cis-1,4-type; use is preferably made, among these synthetic polyisoprenes, of polyisoprenes having a content (molar %) of cis-1,4-bonds of greater than 90%, more preferably still of greater than 98%.

More preferably, the content of second diene elastomer, in particular of isoprene elastomer (especially of natural rubber), is within a range from 5 to 50 phr, more preferably still within a range from 10 to 40 phr.

The diene elastomers described above might also be combined with, in a minor amount, synthetic elastomers other than diene elastomers, indeed even polymers other than elastomers, for example thermoplastic polymers.

### I.2—Reinforcing Inorganic Filler

The composition of the tread of the tire according to the invention has the essential characteristic of comprising a reinforcing inorganic filler (such as silica) in a proportion of 90 to 150 phr, preferably of 105 to 145 phr.

“Reinforcing inorganic filler” should be understood here as meaning any inorganic or mineral filler, whatever its colour and its origin (natural or synthetic), also known as “white” filler, “clear” filler or even “non-black” filler, in contrast to carbon black, capable of reinforcing, by itself alone, without means other than an intermediate coupling agent, a rubber composition intended for the manufacture of tires, in other words capable of replacing, in its reinforcing role, a conventional tire-grade carbon black; such a filler is generally characterized, in a known way, by the presence of hydroxyl (—OH) groups at its surface.

Mineral fillers of the siliceous type, preferably silica (SiO₂), are suitable in particular as reinforcing inorganic fillers. The silica used can be any reinforcing silica known to a person skilled in the art, in particular any precipitated or fumed silica exhibiting a BET specific surface and a CTAB specific surface both of less than 450 m²/g, preferably from 30 to 400 m²/g, in particular between 60 and 300 m²/g. Mention will be made, as highly dispersible precipitated silicas (“HDSs”), for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface as described in Application WO 03/16387. Mention will also be made, as reinforcing inorganic filler, of mineral fillers of the aluminous type, in particular alumina (Al₂O₃) or aluminium (oxide) hydroxides, or else reinforcing titanium oxides.

According to a preferred embodiment of the invention, the reinforcing inorganic filler comprises from 50% to 100% by weight of silica; in other words, the silica represents from 50% to 100% by weight of the reinforcing inorganic filler.

A person skilled in the art will understand that a reinforcing filler of another nature, in particular organic nature, such as carbon black, might be used as filler equivalent to the reinforcing inorganic filler described in the present section, provided that this reinforcing filler is covered with an inorganic layer, such as silica, or else comprises, at its surface, functional sites, in particular hydroxyls, requiring the use of a coupling agent in order to form the connection between the filler and the elastomer. Mention may be made, by way of example, for example, of carbon blacks for tires, such as described, for example, in patent documents WO 96/37547 and WO 99/28380.

According to an advantageous embodiment, the composition of the tread can comprise carbon black. The carbon black, when it is present, is preferably used at a content of less than 20 phr, more preferably of less than 10 phr (for example between 0.5 and 20 phr, in particular between 2 and 10 phr). Within the intervals indicated, benefit is derived from the colouring properties (black pigmenting agent) and UV-stabilizing properties of the carbon blacks without, moreover, penalizing the performances introduced by the reinforcing inorganic filler.

In order to couple the reinforcing inorganic filler to the diene elastomer, use is made, in a well-known way, of a coupling agent (or bonding agent) intended to provide a satisfactory connection, of chemical and/or physical nature, between the inorganic filler (surface of its particles) and the diene elastomer. This coupling agent is at least bifunctional. Use is made in particular of at least bifunctional organosilanes or polyorganosiloxanes.

Use is made in particular of silane polysulphides, referred to as “symmetrical” or “unsymmetrical” depending on their specific structure, such as described, for example, in Applications WO 03/002648 (or US 2005/016651) and WO 03/002649 (or US 2005/016650).

Particularly suitable, without the definition below being limiting, are silane polysulphides corresponding to the following general formula (I):

Z-A-Sₓ-A-Z, in which: (I)
x is an integer from 2 to 8 (preferably from 2 to 5);
the A symbols, which are identical or different, represent a divalent hydrocarbon radical (preferably a C₁-C₁₈ alkylene group or a C₆-C₁₂ arylene group, more particularly a C₁-C₁₀, in particular C₁-C₄, alkylene, especially propylene);
the Z symbols, which are identical or different, correspond to one of the three formulae below:

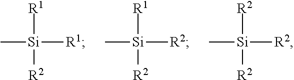

in which:
the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, in particular C₁-C₄ alkyl groups, more particularly methyl and/or ethyl);
the R², radicals, which are substituted or unsubstituted and identical to or different from one another, represent a C₁-C₁₈ alkoxyl or C₅-C₁₈ cycloalkoxyl group (preferably a group selected from C₁-C₈ alkoxyls and C₅-C₈ cycloalkoxyls, more preferably still a group selected from C₁-C₄ alkoxyls, in particular methoxyl and ethoxyl).

In the case of a mixture of alkoxysilane polysulphides corresponding to the above formula (I), in particular normal commercially available mixtures, the mean value of the “x” indices is a fractional number preferably of between 2 and 5, more preferably of approximately 4.

However, the invention can also advantageously be carried out, for example, with alkoxysilane disulphides (x=2).

Mention will more particularly be made, as examples of silane polysulphides, of bis((C₁-C₄)alkoxyl(C₁-C₄)alkylsilyl(C₁-C₄)alkyl) polysulphides (in particular disulphides, trisulphides or tetrasulphides), such as, for example, bis(3-trimethoxysilylpropyl) or bis(3-triethoxysilylpropyl) polysulphides. Use is in particular made, among these compounds, of bis(3-triethoxysilylpropyl) tetrasulphide, abbreviated to TESPT, of formula [(C₂H₅O)₃Si(CH₂)₃S₂]₂, or bis(triethoxysilylpropyl) disulphide, abbreviated to TESPD, of formula [(C₂H₅O)₃Si(CH₂)₃S]₂. Mention will also be made, as preferred examples, of bis(mono(C₁-C₄)alkoxyldi(C₁-C₄)alkylsilylpropyl) polysulphides (in particular disulphides, trisulphides or tetrasulphides), more particularly bis(monoethoxydimethylsilylpropyl) tetrasulphide, such as described in the abovementioned Patent Application WO 02/083782 (or U.S. Pat. No. 7,217,751).

Mention will in particular be made, as examples of coupling agents other than an alkoxysilane polysulphide, of bifunctional POSs (polyorganosiloxanes), or else of hydroxysilane polysulphides (R²═OH in the above formula I), such as described, for example, in Patent Applications WO 02/30939 (or U.S. Pat. No. 6,774,255), WO 02/31041 (or US 2004/051210) and WO2007/061550, or else of silanes or POSs bearing azodicarbonyl functional groups, such as described, for example, in Patent Applications WO 2006/125532, WO 2006/125533 and WO 2006/125534.

Mention will be made, as examples of other silane sulphides, for example, of the silanes bearing at least one thiol (—SH) functional group (referred to as mercaptosilanes) and/or at least one masked thiol functional group, such as described, for example, in Patents or Patent Applications U.S. Pat. No. 6,849,754, WO 99/09036, WO 2006/023815, WO 2007/098080, WO 2008/055986 and WO 2010/072685.

Of course, use might also be made of mixtures of the coupling agents described above, as described in particular in the abovementioned Application WO 2006/125534.

The content of coupling agent is preferably between 2 and 20 phr, more preferably between 3 and 15 phr.

### I.3—Plasticizing System

The composition of the tread of the tire according to the invention has the other essential characteristic of comprising a plasticizing system comprising:
according to a content A of between 10 and 60 phr, a hydrocarbon resin exhibiting a Tg of greater than 20° C.;
according to a content B of between 10 and 60 phr, a plasticizer which is liquid at 20° C., the Tg of which is less than −20° C.;
it being understood that A+B is greater than 45 phr.

Preferably, the content of overall plasticizing system A+B is between 50 and 100 phr, more preferably between 50 and 85 phr.

The liquid plasticizer is liquid at 20° C.; it is described as a “low Tg” plasticizer, that is to say that it exhibits a Tg of less than −20° C., preferably of less than −40° C.

Any extending oil, whether of aromatic or non-aromatic nature, any liquid plasticizing agent known for its plasticizing properties with regard to diene elastomers, can be used. At ambient temperature (20° C.), these plasticizers or these oils, which are more or less viscous, are liquids (that is to say, as a reminder, substances which have the ability to eventually assume the shape of their container), in contrast in particular to plasticizing hydrocarbon resins, which are by nature solids at ambient temperature.

Any extending oil, whether of aromatic or non-aromatic nature, any liquid plasticizing agent known for its plasticizing properties with regard to diene elastomers, can be used. At ambient temperature (20° C.), these plasticizers or these oils, which are more or less viscous, are liquids (that is to say, as a reminder, substances which have the ability to eventually assume the shape of their container), in contrast in particular to plasticizing hydrocarbon resins, which are by nature solids at ambient temperature.

Liquid plasticizing agents selected from the group consisting of liquid diene polymers, polyolefin oils, naphthenic oils, paraffinic oils, DAE (Distillate Aromatic Extracts) oils, MES (Medium Extracted Solvates) oils, TDAE (Treated Distillate Aromatic Extracts) oils, RAE (Residual Aromatic Extracts) oils, TRAE (Treated Residual Aromatic Extracts) oils, SRAE (Safety Residual Aromatic Extracts) oils, mineral oils, vegetable oils, ether plasticizers, ester plasticizers, phosphate plasticizers, sulphonate plasticizers and the mixtures of these compounds are particularly suitable. According to a more preferred embodiment, the liquid plasticizing agent is selected from the group consisting of MES oils, TDAE oils, naphthenic oils, vegetable oils and the mixtures of these oils.

According to a preferred embodiment of the invention, the liquid plasticizer, in particular petroleum oil, is of the non-aromatic type. A liquid plasticizer is described as non-aromatic when it exhibits a content of polycyclic aromatic compounds, determined with the extract in DMSO according to the IP 346 method, of less than 3% by weight, with respect to the total weight of the plasticizer. Therefore, use may preferably be made of a liquid plasticizing agent selected from the group consisting of MES oils, TDAE oils, naphthenic oils (of low or high viscosity, in particular hydrogenated or non-hydrogenated), paraffinic oils and the mixtures of these oils. RAE oils, TRAE oils and SRAE oils or the mixtures of these oils, which contain low contents of polycyclic compounds, are also suitable as petroleum oil.

According to another specific embodiment, the liquid plasticizer is a terpene derivative; mention may in particular be made, by way of example, of the product Dimarone from Yasuhara.

The liquid polymers resulting from the polymerization of olefins or dienes, such as, for example, those selected from the group consisting of polybutenes, polydienes, in particular polybutadienes, polyisoprenes, copolymers of butadiene and isoprene, copolymers of butadiene or isoprene and styrene, and the mixtures of these liquid polymers, are also suitable. The number-average molar mass of such liquid polymers is preferably within a range extending from 500 g/mol to 50 000 g/mol, more preferably from 1000 g/mol to 10 000 g/mol. Mention may in particular be made, by way of example, of the Ricon products from Sartomer.

According to another preferred embodiment of the invention, the liquid plasticizer is a vegetable oil. Use is preferably made of an oil selected from the group consisting of linseed, safflower, soybean, maize, cottonseed, rapeseed, castor, tung, pine, sunflower, palm, olive, coconut, peanut and grapeseed oils, and the mixtures of these oils, in particular a sunflower oil. This vegetable oil, in particular sunflower oil, is more preferably an oil rich in oleic acid, that is to say that the fatty acid (or all of the fatty acids, if several are present) from which it derives comprises oleic acid according to a fraction by weight at least equal to 60%, more preferably at least equal to 70%, in particular equal to or greater than 80%.

According to another specific embodiment of the invention, the liquid plasticizer is an ether; mention may be made, for example, of polyethylene glycols or polypropylene glycols.

The liquid plasticizers selected from the group consisting of ester plasticizers, phosphate plasticizers, sulphonate plasticizers and the mixtures of these compounds are also suitable. The triesters selected from the group consisting of triesters of carboxylic acid, of phosphoric acid or of sulphonic acid and the mixtures of these triesters are suitable in particular. Mention may in particular be made, as examples of carboxylic acid ester plasticizers, of the compounds selected from the group consisting of trimellitates, pyromellitates, phthalates, 1,2-cyclohexanedicarboxylates, adipates, azelates, sebacates, glycerol triesters and the mixtures of these compounds. Mention may in particular be made, among the triesters, of glycerol triesters, preferably predominantly composed (for more than 50% by weight, more preferably for more than 80% by weight) of an unsaturated C₁₈ fatty acid, that is to say selected from the group consisting of oleic acid, linoleic acid, linolenic acid and the mixtures of these acids; more preferably, whether it is of synthetic or natural origin, the fatty acid used is composed, for more than 60% by weight, more preferably still for more than 70% by weight, of oleic acid; such triesters (trioleates) having a high content of oleic acid, of natural or synthetic origin, are well known; they have been described, for example, in Application WO 02/088238, as plasticizing agents in treads for tires. Mention may be made, as phosphate plasticizers, for example, of those which comprise between 12 and 30 carbon atoms, for example trioctyl phosphate.

The plasticizing hydrocarbon resin exhibits a Tg of greater than 20° C.

The designation “resin” is reserved in the present patent application, by definition, for a compound which is solid at ambient temperature (20° C.), in contrast in particular to the liquid plasticizing agent described above.

Hydrocarbon resins are polymers well known to a person skilled in the art, essentially based on carbon and hydrogen but being able to comprise other types of atoms, which can be used in particular as plasticizing agents or tackifying agents in polymer matrices. They are by nature miscible (i.e., compatible) at the contents used with the polymer compositions for which they are intended, so as to act as true diluents. They have been described, for example, in the work entitled “Hydrocarbon Resins” by R. Mildenberg, M. Zander and G. Collin (New York, VCH, 1997, ISBN 3-527-28617-9), Chapter 5 of which is devoted to their applications, in particular in the tire rubber field (5.5. “Rubber Tires and Mechanical Goods”). They can be aliphatic, cycloaliphatic, aromatic, hydrogenated aromatic, of the aliphatic/aromatic type, that is to say based on aliphatic and/or aromatic monomers. They can be natural or synthetic, based or not based on petroleum (if such is the case, also known under the name of petroleum resins). Their Tg is preferably greater than 30° C., in particular between 30° C. and 95° C.

In a known way, these hydrocarbon resins can also be described as thermoplastic resins in the sense that they soften when heated and can thus be moulded. They can also be defined by a softening point or temperature. The softening point of a hydrocarbon resin is generally greater by approximately 50 to 60° C. than its Tg value. The softening point is measured according to Standard ISO 4625 (Ring and Ball method). The macrostructure (Mw, Mn and PI) is determined by size exclusion chromatography (SEC) as indicated below.

As a reminder, the SEC analysis, for example, consists in separating the macromolecules in solution according to their size through columns filled with a porous gel; the molecules are separated according to their hydrodynamic volume, the bulkiest being eluted first. The sample to be analysed is simply dissolved beforehand in an appropriate solvent, tetrahydrofuran, at a concentration of 1 g/litre. The solution is then filtered through a filter with a porosity of 0.45 μm, before injection into the apparatus. The apparatus used is, for example, a Waters Alliance chromatographic line according to the following conditions: elution solvent: tetrahydrofuran; temperature 35° C.; concentration 1 g/litre; flow rate: 1 ml/min; volume injected: 100 μl; Moore calibration with polystyrene standards; set of 3 Waters columns in series (Styragel HR4E, Styragel HR1 and Styragel HR 0.5); detection by differential refractometer (for example, Waters 2410) which can be equipped with operating software (for example, Waters Millenium).

A Moore calibration is carried out with a series of commercial polystyrene standards having a low PI (less than 1.2), with known molar masses, covering the range of masses to be analysed. The weight-average molar mass (Mw), the number-average molar mass (Mn) and the polydispersity index (PI=Mw/Mn) are deduced from the data recorded (curve of distribution by mass of the molar masses). All the values for molar masses shown in the present patent application are thus relative to calibration curves produced with polystyrene standards.

According to a preferred embodiment of the invention, the hydrocarbon resin exhibits at least any one, more preferably all, of the following characteristics:
a Tg of greater than 20° C. (in particular between 30° C. and 100° C.), more preferably of greater than 30° C. (in particular between 30° C. and 95° C.);
a softening point of greater than 50° C. (in particular between 50° C. and 150° C.);
a number-average molar mass (Mn) of between 400 and 2000 g/mol, preferably between 500 and 1500 g/mol;
a polydispersity index (PI) of less than 3, preferably of less than 2 (as a reminder: PI=Mw/Mn with Mw the weight-average molar mass).

Mention may be made, as examples of such hydrocarbon resins, of those selected from the group consisting of cyclopentadiene (abbreviated to CPD) homopolymer or copolymer resins, dicyclopentadiene (abbreviated to DCPD) homopolymer or copolymer resins, terpene homopolymer or copolymer resins, C₅ fraction homopolymer or copolymer resins, C₉ fraction homopolymer or copolymer resins, α-methylstyrene homopolymer or copolymer resins and the mixtures of these resins. Mention may more particularly be made, among the above copolymer resins, of those selected from the group consisting of (D)CPD/vinylaromatic copolymer resins, (D)CPD/terpene copolymer resins, terpene/phenol copolymer resins, (D)CPD/C₅ fraction copolymer resins, (D)CPD/C₉ fraction copolymer resins, terpene/vinylaromatic copolymer resins, terpene/phenol copolymer resins, C₅ fraction/vinylaromatic copolymer resins and the mixtures of these resins.

The term “terpene” combines here, in a known way, α-pinene, β-pinene and limonene monomers; use is preferably made of a limonene monomer, which compound exists, in a known way, in the form of three possible isomers: L-limonene (laevorotatory enantiomer), D-limonene (dextrorotatory enantiomer) or else dipentene, a racemate of the dextrorotatory and laevorotatory enantiomers. Suitable as vinylaromatic monomer are, for example: styrene, α-methylstyrene, ortho-methylstyrene, meta-methylstyrene, para-methylstyrene, vinyltoluene, para(tert-butyl)styrene, methoxystyrenes, chlorostyrenes, hydroxystyrenes, vinylmesitylene, divinylbenzene, vinylnaphthalene or any vinylaromatic monomer resulting from a C₉ fraction (or more generally a C₈ to C₁₀ fraction).

More particularly, mention may be made of the resins selected from the group consisting of (D)CPD homopolymer resins, (D)CPD/styrene copolymer resins, polylimonene resins, limonene/styrene copolymer resins, limonene/D(CPD) copolymer resins, C₅ fraction/styrene copolymer resins, C₅ fraction/C₉ fraction copolymer resins and the mixtures of these resins.

All the above resins are well known to a person skilled in the art and are commercially available, for example sold by DRT under the name Dercolyte as regards polylimonene resins, by Neville Chemical Company under the name Super Nevtac, by Kolon under the name Hikorez or by Exxon Mobil under the name Escorez as regards C₅ fraction/styrene resins or C₅ fraction/C₉ fraction resins, or else by Struktol under the name 40 MS or 40 NS (mixtures of aromatic and/or aliphatic resins).

### I.4—Various Additives

The rubber compositions of the treads of the tires in accordance with the invention also comprise all or a portion of the usual additives generally used in elastomer compositions intended for the manufacture of treads, such as, for example, pigments, protective agents, such as antiozone waxes, chemical antiozonants or antioxidants, other plasticizing agents than those mentioned above, antifatigue agents, reinforcing resins, methylene acceptors (for example phenolic novolak resin) or methylene donors (for example HMT or H3M), a crosslinking system based either on sulphur, or on sulphur donors and/or on peroxide and/or on bismaleimides, vulcanization accelerators or vulcanization activators.

These compositions can also comprise, in addition to the coupling agents, coupling activators, agents for covering the inorganic fillers or more generally processing aids capable, in a known way, by virtue of an improvement in the dispersion of the filler in the rubber matrix and of a lowering of the viscosity of the compositions, of improving their ability to be processed in the raw state, these agents being, for example, hydrolysable silanes, such as alkylalkoxysilanes, polyols, polyethers, primary, secondary or tertiary amines, or hydroxylated or hydrolysable polyorganosiloxanes.

### I.5—Preparation of the Rubber Compositions

The compositions used in the treads of the tires of the invention can be manufactured in appropriate mixers, using two successive phases of preparation well known to a person skilled in the art: a first phase of thermomechanical working or kneading (“non-productive” phase) at high temperature, up to a maximum temperature of between 110° C. and 190° C., preferably between 130° C. and 180° C., followed by a second phase of mechanical working (“productive” phase) down to a lower temperature, typically of less than 110° C., for example between 40° C. and 100° C., during which finishing phase the crosslinking system is incorporated.

The process for preparing such compositions comprises, for example, the following stages:
thermomechanically kneading (for example in one or more goes) the diene elastomer (E-SBR plus the optional second elastomer) with the reinforcing inorganic filler, the coupling agent, if appropriate the carbon black and the plasticizing system, until a maximum temperature of between 110° C. and 190° C. is reached (“non-productive” phase);
cooling the combined mixture to a temperature of less than 100° C.;
subsequently incorporating, during a second stage (“productive”), a crosslinking system;
kneading everything up to a maximum temperature of less than 110° C.

By way of example, the non-productive phase is carried out in a single thermomechanical stage during which, in a first step, all the base constituents (the diene elastomers, the plasticizing system, the reinforcing inorganic filler and the coupling agent) are introduced into an appropriate mixer, such as a standard internal mixer, followed, in a second step, for example after kneading for one to two minutes, by the other additives, optional additional agents for covering the filler or optional additional processing aids, with the exception of the crosslinking system. The total duration of the kneading, in this non-productive phase, is preferably between 1 and 15 min.

After cooling the mixture thus obtained, the crosslinking system is then incorporated in an external mixer, such as an open mill, maintained at a low temperature (for example between 40° C. and 100° C.). The combined mixture is then mixed (productive phase) for a few minutes, for example between 2 and 15 min.

The crosslinking system proper is preferably based on sulphur and on a primary vulcanization accelerator, in particular on an accelerator of the sulphenamide type. Various known secondary vulcanization accelerators or vulcanization activators, such as zinc oxide, stearic acid, guanidine derivatives (in particular diphenylguanidine), and the like, come to be added to this vulcanization system, being incorporated during the first non-productive phase and/or during the productive phase. The sulphur content is preferably between 0.5 and 3.0 phr and the content of the primary accelerator is preferably between 0.5 and 5.0 phr.

Use may be made, as (primary or secondary) accelerator, of any compound capable of acting as accelerator of the vulcanization of diene elastomers in the presence of sulphur, in particular accelerators of the thiazole type and their derivatives and accelerators of the thiuram and zinc dithiocarbamate types. These accelerators are more preferably selected from the group consisting of 2-mercaptobenzothiazyl disulphide (abbreviated to “MBTS”), N-cyclohexyl-2-benzothiazolesulphenamide (abbreviated to “CBS”), N,N-dicyclohexyl-2-benzothiazolesulphenamide (abbreviated to “DCBS”), N-(tert-butyl)-2-benzothiazolesulphenamide (abbreviated to “TBBS”), N-(tert-butyl)-2-benzothiazolesulphenimide (abbreviated to “TBSI”), zinc dibenzyldithiocarbamate (abbreviated to “ZBEC”) and the mixtures of these compounds. Preferably, a primary accelerator of the sulphenamide type is used.

The final composition thus obtained can subsequently be calendered, for example in the form of a sheet or of a plaque, in particular for laboratory characterization, or also extruded, for example in order to form a rubber profiled element used in the manufacture of a tread.

The invention relates to the tires described above, both in the raw state (that is to say, before curing) and in the cured state (that is to say, after crosslinking or vulcanization).

### II—EXAMPLES OF THE IMPLEMENTATION OF THE INVENTION

### II.1—Preparation of the Compositions

The following tests are carried out in the following way: the diene elastomer (E-SBR plus the optional second diene elastomer), the reinforcing inorganic filler, the plasticizing system and also the various other ingredients, with the exception of the vulcanization system, are successively introduced into an internal mixer (final degree of filling: approximately 70% by volume), the initial vessel temperature of which is approximately 60° C. Thermomechanical working (non-productive phase) is then carried out in one stage, which lasts in total approximately from 3 to 4 min, until a maximum “dropping” temperature of 165° C. is reached.

The mixture thus obtained is recovered and cooled and then sulphur and an accelerator of sulphenamide type are incorporated on a mixer (homofinisher) at 30° C., everything being mixed (productive phase) for an appropriate time (for example between 5 and 12 min) The compositions thus obtained are subsequently extruded in the form of a tread.

### I.2—Running Tests on the Tires

The aim of the tests which follow is to demonstrate the improvement in the wet grip of tires for passenger vehicles according to the invention, in comparison with tires, the tread of which uses a conventional composition.

For this, seven rubber compositions for a tread were prepared as indicated above, five in accordance with the invention (hereinafter denoted C.3 to C.7) and two not in accordance with the invention (control compositions hereinafter denoted C.1 and C.2).

Their formulations (expressed in phr) are presented in the appended Table 1.

The composition C.1 is a first control composition, based on solution SBR (SSBR) and on BR, which can be used in treads of “Green Tires” (having a low rolling resistance) for passenger vehicles. In the second control composition C.2, the contents of reinforcing inorganic filler and of plasticizing system have been increased to the same levels as those of the composition C.3 according to the invention, without, however, changing the elastomer matrix (SSBR and BR).

The compositions C.3 to C.7 according to the invention thus differ essentially from the control compositions C.1 and C.2 in their replacement of 60 phr of solution SBR with 60 phr of emulsion SBR having a high trans content in accordance with the invention. The compositions C.4 to C.7 additionally comprise a part of natural rubber (NR) in place of the BR elastomer of the composition C.3.

The compositions C.1 to C.7 are moreover all characterized by high contents of reinforcing inorganic filler (100 or 120 phr) and of total plasticizing system (55 to 80 phr). The plasticizing system used here is a mixture of a thermoplastic hydrocarbon resin (C₅/C₉ resin) and of a TDAE oil.

Tires denoted T.1 to T.7, comprising treads respectively based on the compositions C.1 to C.7, were fitted to a passenger vehicle in order to be subjected to tests of wet grip and of measurement of rolling resistance, as shown below. The results of the tests carried out on these tires are summarized in Table 2.

The wet grip test consists in fitting tires to the front and rear of a motor vehicle of “Volkswagen” make, “Golf 6” model, equipped with an ABS braking system. The tires are inflated to nominal pressure. The ambient temperature of the tests is 25° C. The distance necessary to go from 80 km/h to 10 km/h is measured during sudden braking in a straight line on water-sprayed ground (bituminous concrete). A value greater than that of the control, arbitrarily set at 100, indicates an improved result, that is to say a shorter braking distance.

It is found that the braking distances on wet ground of the tires T.3 to T.7 in accordance with the invention, that is to say for which the tread comprises a rubber composition based on E-SBR having a high trans content, in combination with high contents of inorganic filler and of plasticizer, are in all cases markedly lower than those of the control tires (performance indices increased by 9% to 16%). Such treads thus make it possible to greatly improve the wet grip of the tires.

Furthermore, the rolling resistance of the tires is measured on a rolling drum, according to the ISO 87-67 (1992) method. A value lower than that of the control, arbitrarily set at 100, indicates a degraded result, that is to say a higher rolling resistance. It is noted that the tires T.3 to T.7 in accordance with the invention all exhibit a rolling resistance value equal to or very slightly greater than those of the control tires T.1. and T.2.

In conclusion, the results of these tests demonstrate that the use in a tread of an emulsion SBR having a high content of trans -1,4-butadienyl units, in the presence of high contents of reinforcing inorganic filler and of plasticizers, makes it possible to obtain a tire having a very substantially improved wet grip, in comparison with a Green Tire composition, without damaging or virtually without damaging the rolling resistance.

TABLE 1

| | Composition No. | | | | | | |
|---|---|---|---|---|---|---|---|
| | C.1 | C.2 | C.3 | C.4 | C.5 | C.6 | C.7 |
| Solution SBR (1) | 60 | 60 | — | — | — | — | — |
| BR (2) | 40 | 40 | 40 | 30 | 20 | 15 | 20 |
| NR (3) | — | — | — | 10 | 20 | 25 | 30 |
| Emulsion SBR (4) | — | — | 60 | 60 | 60 | 60 | 50 |
| Inorganic filler (5) | 100 | 120 | 120 | 120 | 120 | 100 | 120 |
| Coupling agent (6) | 8.5 | 8.5 | 8.5 | 8.5 | 8.5 | 8.5 | 8.5 |
| Carbon black (7) | 4 | 4 | 4 | 4 | 4 | 4 | 4 |
| Resin (8) | 30 | 35 | 35 | 35 | 35 | 30 | 35 |
| Liquid plasticizers (9) | 25 | 45 | 45 | 40 | 40 | 25 | 30 |
| Total plasticizer | 55 | 80 | 80 | 75 | 75 | 55 | 65 |
| Anti-oxidant (10) | 2.5 | 2.5 | 2.5 | 2.5 | 2.5 | 2.5 | 2.5 |
| Stearic acid (11) | 2 | 2 | 2 | 2 | 2 | 2 | 2 |
| ZnO (12) | 1.6 | 1.6 | 1.6 | 1.6 | 1.6 | 1.6 | 1.6 |
| DPG (13) | 1.5 | 1.5 | 1.5 | 1.5 | 1.5 | 1.5 | 1.5 |
| CBS (14) | 2 | 2 | 2 | 2 | 2 | 2 | 2 |
| Sulphur | 1.4 | 1.4 | 1.4 | 1.4 | 1.4 | 1.4 | 1.4 |

(1) Solution SBR (content expressed as dry SBR) with 41% of styrene units and 59% of butadiene units; with, for the butadiene part, 24% of 1,2- units, 30% of cis-1,4- units and 46% of trans-1,4- units (Tg = −28° C.);
(2) BR with 4.3% of 1,2- units, 2.7% of trans-1,4- units and 93% of cis-1,4- units (Tg = −106° C.);
(3) Peptized natural rubber;
(4) Emulsion SBR (Buna SB 1739 from Styron); with 40% of styrene units and 60% of butadiene units; with, for the butadiene part, 16% of 1,2- units, 14% of cis-1,4- units and 70% of trans-1,4- units; (Tg = 30° C.);
(5) Silica (Ultrasil 7000 GR from Degussa);
(6) Silane TESPT (Si69 from Degussa);
(7) Carbon black N234 (ASTM grade);
(8) C₅/C₉ resin (Escorez ECR-373 from Exxon);
(9) TDAE oil (Vivatec 500 from Klaus Dahleke);
(10) N-(1,3-dimethylbuty1)-N-phenylparaphenylenediamine (Santoflex 6-PPD from Flexsys);
(11) Stearin (Pristerene from Uniqema);
(12) Zinc oxide (industrial grade-Umicore);
(13) DPG = diphenylguanidine (Perkacit DPG from Flexsys);
(14) N-Cyclohexyl-2-benzothiazolesulphenamide (Santocure CBS from Flexsys).

TABLE 2

| | Tire | | | | | | |
|---|---|---|---|---|---|---|---|
| | T.1 | T.2 | T.3 | T.4 | T.5 | T.6 | T.7 |
| Braking on wet | 100 | 100 | 110 | 116 | 115 | 110 | 109 |
| ground | | | | | | | |
| Rolling resistance | 100 | 98 | 98 | 98 | 98 | 100 | 98 |

1. A tire, the tread of which comprises a rubber composition comprising at least:
from 40 to 100 phr of an emulsion styrene/butadiene copolymer “E-SBR”, referred to as first diene elastomer, the content of trans-1,4-butadienyl units of which is greater than 50% by weight of the total of the butadienyl units;
optionally, from 0 to 60 phr of another diene elastomer referred to as second diene elastomer;
from 90 to 150 phr of a reinforcing inorganic filler;
a plasticizing system comprising:
according to a content A of between 10 and 60 phr, a hydrocarbon resin exhibiting a Tg of greater than 20° C.;
according to a content B of between 10 and 60 phr, a plasticizer which is liquid at 20° C., the Tg of which is less than −20° C.;
it being understood that A+B is greater than 45 phr.

2. A tire according to claim 1, in which the content of trans-1,4-butadienyl units of the E-SBR is greater than 60% by weight of the total of the butadienyl units.

3. A tire according to claim 1, in which the styrene content of the E-SBR is at most equal to 50% by weight of the copolymer.

4. A tire according to claim 1, in which the rubber composition comprises from 45 to 100 phr of E-SBR.

5. A tire according to claim 1 in which the second diene elastomer is selected from the group consisting of natural rubber, synthetic polyisoprenes, butadiene copolymers, isoprene copolymers and the mixtures of these elastomers.

6. A tire according to claim 5, in which the second diene elastomer is selected from the group consisting of polybutadienes, natural rubber and the mixtures of these elastomers.

7. A tire according to claim 1, in which A+B is between 50 and 100 phr.

8. A tire according to claim 1, in which the hydrocarbon resin is selected from the group consisting of cyclopentadiene homopolymer or copolymer resins, dicyclopentadiene homopolymer or copolymer resins, terpene homopolymer or copolymer resins, C₅ fraction homopolymer or copolymer resins, C₉ fraction homopolymer or copolymer resins, α-methylstyrene homopolymer or copolymer resins and the mixtures of these resins.

9. A tire according to claim 1, in which the liquid plasticizer is selected from the group consisting of liquid diene polymers, polyolefin oils, naphthenic oils, paraffinic oils, DAE oils, MES oils, TDAE oils, RAE oils, TRAE oils, SRAE oils, mineral oils, vegetable oils, ether plasticizers, ester plasticizers, phosphate plasticizers, sulphonate plasticizers and the mixtures of these compounds.

10. A tire according to claim 9, in which the liquid plasticizing agent is selected from the group consisting of MES oils, TDAE oils, naphthenic oils, vegetable oils and the mixtures of these oils.

11. A tire according to claim 1, in which the reinforcing inorganic filler comprises silica.

12. A tire according to claim 11, in which the rubber composition comprises a mixture of carbon black and silica.
